(19) United States
(12) Patent Application Publication
(10) Pub. No.: US 2002/0095850 A1
(43) Pub. Date: Jul. 25, 2002

(54) Method and apparatus for fishing

(76) Inventor: Edwin A. Jones, Corpus Christi, TX (US)

Correspondence Address: Hugh R. Kress, 2400 Bank One Center, 910 Travis Street, Houston, TX, 77002, US

(21) Appl. No.: 10/017,300

(22) Filed: Dec. 14, 2001

Related U.S. Application Data
(60) Provisional application No. 60/262,785, filed on Jan. 19, 2001.

(51) Int. Cl. A01K 1/00

(52) U.S. Cl. 43/4

(57) ABSTRACT

A method and fishing apparatus of the type for utilizing wind power to extend the range of a fisherman is provided. The fishing apparatus and method includes: a base maneuverable across the surface of a body of water, the base including a bow rail, a stern rail and a pair of side rails interconnected to form a substantially rectangular base; at least two buoyant pontoons connected to the base; a sail attitude chain connected along a portion of the base; a sail assembly having a mast and a batten frame carrying a sail, the mast being rotatably connected to the bow rail; a fastening mechanism extending from a clew portion of the sail assembly connectable to the sail attitude chain; and a line having at least one hook drop extending therefrom connected to the base.

### RELATED APPLICATIONS

This Application is a non-provisional application claiming priority to provisional U.S. application serial No. 60/262,785 filed on Jan. 19, 2001 and is hereby incorporated by reference in its entirety herein.

### FIELD OF THE INVENTION

The present invention relates generally to fishing, and more particularly relates to a method and apparatus for fishing utilizing a wind propulsion unit to extend the fishing range of a fisherman.

### BACKGROUND OF THE INVENTION

Various devices have been proposed over the years to assist persons in the endeavor of fishing. Among these are a class of devices sometime referred to as a “sailing trotline” in which a structure adapted to capture wind power (i.e., a sail) is mounted upon a float to which one or more fishing lines is attached. Such devices enable a fisherman to remain ashore or on board a sailing vessel while the trotline is propelled by the wind some distance away from the fisherman. U.S. Pat. No. 4,237,642 to Petorella, entitled “Sailing Trotline” (“Petorella”) is believed to be exemplary of such prior art fishing devices.

There are a number of perceived deficiencies with prior art sailing trotline systems. Among these shortcomings is the lack of maneuverability and control afforded to users of prior art systems such as that proposed by Petorella. Petorella teaches a rectangular sail-like structure having a limited degree of adjustability. The overall configuration of the Petorella device is such that the Petorella device would likely be rather inefficient with regard to utilization of wind power, and not particularly effective with regard to maneuverability and achieving realistic sailing motion. Moreover, the limited adjustability of the Petorella sail-like structure affords only a limited angular range within which the device may be maneuvered.

It is thus desired to provide a fishing apparatus that aids a fisherman in reaching locations that may be out of casting range. It is a further desire to provide a wind propulsion unit that is operable in various wind conditions to permit a fisherman to maneuver hook drops along a desired path. It is a still further desire to provide a wind propulsion system that has a maneuverable sail to utilize the prevalent winds to reach fishing areas from a distance and/or areas that are unreachable by prior art fishing methods and apparatus. It is a still further desire to provide a rudder to the wind propulsion unit to provide additional stability and control over the wind propulsion unit. It is a still further desire to provide a maneuverable fishing apparatus that can be quickly assembled for use and disassembled for compact storage and transport.

### SUMMARY OF THE INVENTION

It is thus one feature of the present invention to provide a device and apparatus that allows a fisherman to extend his effective fishing distance beyond the limits of the normal casting range. This extended reach allows the fisherman to fish areas with out spooking the fish as well as reach areas that prior hereto may not have been safely reached by wading or a vessel. The device also provides additional fishing opportunity for those that may be physically constrained.

It is a further feature to provide a device that can be assembled for use and disassembled for compact storage and transportation.

It is a still further feature of the present invention to provide a device that has adjustable maneuvering elements so as to be effective in varying wind conditions.

It is a still further feature of the present invention to provide a device that can be used with conventional rod and reel fishing equipment.

Accordingly, a method and fishing apparatus of the type for utilizing wind power to extend the range of a fisherman is provided. The fishing apparatus and method includes: a base maneuverable across the surface of a body of water, the base including a bow rail, a stern rail and a pair of side rails interconnected to form a substantially rectangular base; at least two buoyant pontoons connected to the base; a sail attitude chain connected along a portion of the base; a sail assembly having a mast and a batten frame carrying a sail, the mast being rotatably connected to the bow rail; a fastening mechanism extending from a clew portion of the sail assembly connectable to the sail attitude chain; and a line having at least one hook drop extending therefrom connected to the base.

In one embodiment of the invention, the wind propulsion unit (WPU) includes a sail assembly and a base assembly. The sail assembly including a mast and a batten frame. The base unit including a bow rail, stern rail and a pair of side rails. The material of construction for the WPU is desirably a lightweight, substantially buoyant material that is weather resistant. It is desired to provide material that will withstand the environmental conditions and provide the fisherman with a long lasting fishing device.

The members forming the base and sail assembly are desirably removably connectable so as to provide for disassembly for transportation and storage. Connections may be friction fit, threaded, or of various other means of twist and lock and quick connects to facilitate the collapsible functions of the design. Some or all of the connections may be substantially permanently fixed utilizing an adhesive.

It may be desired to interconnect various members of the WPU with elastic cord to maintain the members in compressive connection when being utilized and maintain the members in proximity to one another when disassembled. In one embodiment of the present invention the various members forming the base are interconnected by an elastic cord in a manner so as to maintain all of the members together when disassembled. In another embodiment of the present invention the right and left half of the base unit are separately connected by elastic cords. In this embodiment it may further be desired to include elastic bands to maintain the right and left half in fitting compression when the base is constructed for use.

Pontoons are connected to the base to provide stable buoyancy to the WPU. In one embodiment of the present invention four pontoons are provided. The pontoons may be connected to the side rails of the base. The pontoons may be connected in varying locations of the WPU depending on stability requirements and WPU size choices.

Some or all of the pontoons may be shaped to aid in maneuvering the fishing apparatus through the water. In embodiments of the invention some or all of the pontoons have tapered bow sections to reduce friction as the WPU moves through the water. Some or all of the pontoons may further include V-tapered hull sections to provide additional stability and to reduce friction as moving across the water.

The WPU provides a positionable sail to provide a wide range of maneuvers and sailing paths desired for varying wind conditions. This versatility in the WPU of the present invention is provided by moveably and/or rotatably connecting the mast to the bow rail and the ability to selectively position the clew end of the sail.

The mast is rotatably connected to the bow rail such that the clew end may be rotated about the connection of the mast to the bow rail. The mast may also be connected to the bow rail in a manner such as to be positionable along the length of the bow rail. One manner of moveably connecting the mast to the bow rail rotatably connecting the mast to the bow rail is by utilizing a T-joint sized to dispose the bow rail through a portion thereof. In an embodiment a locking mechanism(s) may be connected to the connecting joint to secure the connecting joint to the bow rail and to secure the mast in a set position. Such locking mechanisms may include, but is not limited to set screws Guy lines may be provided to maintain the mast in position and connection with the bow rail and/or to provide additional stability.

To further establish the sailing attitude of the WPU the clew end of the sail is attachable to a sail attitude chain. This “chain” which may be any device to which the clew end of the sail may be attached, is positioned along the base. The sail attitude chain may be positioned approximately perpendicular to the side rails or substantially parallel to the side rails. The attitude chain may be moveable along the length of the rails to which it is attached.

For further control and tacking of the WPU, a tacking chain may be connected between the side rails of the WPU. The tacking chain may be constructed of any material to which the fishing line can be attached in selected positions. In one embodiment the tacking chain is attached proximate the bow end of the WPU. The line is connected to tacking chain relative to the positioning of the sail assembly to help maneuver the device.

A rudder may be connected to the stern rail of the WPU. A rudder is an efficient means of imparting direction to the WPU. The rudder may be positionally attached to the stern rail by a sliding connector or the like so that the rudder can be positioned along the length of the stern rail. By selectively positioning the rudder the fisherman can achieve greater fishing coverage of a body of water.

The WPU is functionally connected to a fisherman via a fishing line. A portion of the line has a leader section having at least one hook drop. The hook drop may include singularly or in combination a variety of manners of bait presentation and fishing depths.

Additionally, floats may be connected to the line to serve various purposes. For example, floats may be utilized, singularly or in combination, to identify the location of the leader section, to identify the line for those that may cross the line and to indicate when fish are on the hook drops. These floats may be color-coded and or have light reflective material thereon to increase visibility. It may further be desired to attach weights along portions of the line and/or leader section. The weights may be utilized to achieve desired fishing depths and/or to sink portions of the line to prevent passing water vessels from cutting or becoming entangled in the line.

It may also be desired to attach reflective material and/or a light-emitting source to the WPU. These identifiers aid in locating the device in low light conditions in addition to warning passing water vessels of their presence.

The foregoing has outlined rather broadly the features and technical advantages of the present invention in order that the detailed description of the invention that follows may be better understood. Various combinations of feature may be utilized singularly or in combination to achieve the invention as taught. Additional features and advantages to the invention will be described hereinafter which form the subject of the claims appended hereto.

### BRIEF DESCRIPTION OF THE DRAWINGS

The foregoing and other features and aspects of the subject invention will be best understood with reference to the accompanying drawings of a specific embodiment of the invention, wherein:

FIG. 1 is a representative view of an embodiment of the fishing apparatus of the present invention;

FIG. 2 is a top view of the wind propulsion unit of the present invention;

FIG. 2a is a top view of another embodiment of the base of the wind propulsion unit;

FIG. 3 is a perspective view of a pontoon in isolation;

FIG. 4 is a perspective view of a rudder assembly in isolation;

FIG. 5 is an exploded view of the base disassembled for storage and/or transport;

FIG. 6 is a front view of the wind propulsion unit;

FIG. 7 is a side view of the wind propulsion unit;

FIG. 8 is a side view of the sail assembly in isolation; and

FIG. 9 is an exploded view of the sail assembly disassembled for storage and/or transport.

### DETAILED DESCRIPTION OF A SPECIFIC EMBODIMENT OF THE INVENTION

Refer now to the drawings wherein depicted elements are not necessarily shown to scale and wherein like or similar elements are designated by the same reference numeral through the several Figures.

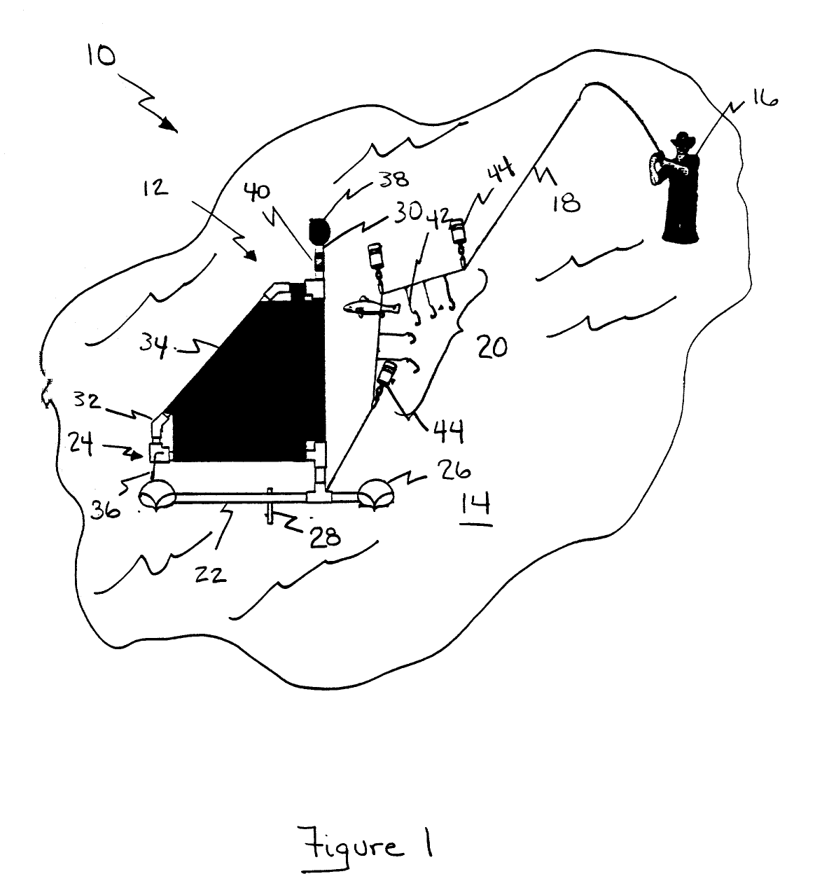

FIG. 1 is a representative view of the fishing apparatus and system of the present invention generally denoted by the numeral 10. Fishing apparatus 10 includes a wind propulsion unit (WPU) 12 moveable through a body of water 14 operationally connected to a fisherman 16 via a line 18 having a leader section 20.

WPU 12 includes a base 22 and a sail assembly 24. In one embodiment of the invention WPU 12 is constructed of a lightweight material such as, but not limited to, chlorinated polyvinyl chloride (CPVC). CPVC is a suitable material for withstanding the salt water and sunlight without significant deterioration. Base 22 includes a plurality of pontoons 26 to aid WPU 12 in traveling through body of water 14. WPU 12 may include a rudder 28 to aid in directing WPU 12 across water 14.

Sail assembly 24 includes a mast 30, a batten frame 32 and a sail 34. Mast 30 is removably connected to base 22. Guy lines (not shown) may be connected between mast 30 and base 22. Batten frame 32 is connectable to mast 30. Sail 34 is connected along batten frame 32 and mast 30 to form a substantially rectangular shape. Sail 34 maybe constructed of a suitable lightweight durable material such as nylon. An attachment mechanism 36, such as a hook or snap swivel, extends from a clew portion of batten frame 32 for connecting to a sail attitude chain 60 (FIG. 2) positioning sail 34 for directing WPU 12 in a desired direction.

A light 38 may be mounted along or atop mast 30. Light 38 may be a constant emitting beam or flashing beam type light emitting source. Light 38 provides a means for fisherman 16 to track the movement of WPU 12 and to notify others of the location of WPU 12 in water 14. A reflector 40 may be placed on mast 30 to add additional visibility to WPU 12.

Line 18 may be any type of line suitable for fishing such as, but not limited to, monofilament, fluorocarbon, braided and wire lines. A first end of line 18 is connected to a fishing mechanism such as a common rod and reel or automated reel systems. Fishing apparatus and system 10 is particularly suited for a fisherman 16 to guide WPU 12 to locations out of casting distance and to be able to maneuver leader section 20 along a path that cannot be achieved by mere casting and retrieval of bait or lures. A second end of line 18 is connected to WPU 12. Line 18 may be connected along various locations on WPU 12. As shown in the additional Figures, Line 18 may be connected to a tacking chain 62 (FIG. 2).

Leader section 20 is formed along a portion of line 18. At least one hook drop assembly 42 extends from leader section 20. Each hook drop 42 includes at least a line portion and a hook as well known in the art. The line portion may be formed of numerous types of material, as illustrated above, depending on the type of fish desired or likely to be encountered. Hook drop assembly 42 may be connected to leader section by known and yet known fishing knots or various types of swivel connectors. Hook assemblies 42 may be lure type devices or adapted for using live or dead bait. In a preferred embodiment of the present invention a plurality of hook assemblies 42 extend from leader section 20.

It may be desired to include at least one float 44 connected along line 18 to maintain line 18 and in particular hook drops 42 at a desired depth within water 14. Floats 44 may be formed of any material, which will float such as, wood and hollow formed plastics. One desirable material for constructing float 44 is with ETHAFOAM™ (Dow) which is a tough, resilient, lightweight, moisture and chemical resistant closed cell polyethylene that may be race either non-crosslinked or crosslinked. ETHAFOAM™ may be desired over STYROFOAM™ (Dow) due to its durability. A plurality of floats 44 may be utilized to maintain leader section 20 at a specific depth and/or for fisherman 16 to locate leader section 20 relative to WPU 12 and help identify when a fish is on line 18. Floats 44 may be color coded and/or have colored reflectors to more clearly identify the location and positioning of leader section 20.

Although not shown it should be realized that weights may be attached to line 18 and/or hook assemblies 42 to reach desired depths and/or to alleviate the likelihood of vessels crossing and cutting or becoming entangled in line 18.

FIG. 2 is a top view of wind propulsion unit 12 of the present invention. As shown in this embodiment, the bow of base 22 is oriented toward fisherman 16 as indicated by the arrow and the connection of line 18.

Base 22 includes a pair of side rails 46a and 46b a stern rail 48 and a bow rail 50. Rails 46, 48 and 50 are interconnected by joints 52 to form a substantially rectangular base 22. Rails 46, 48 and 50 are desirably frictionally connected to joints 52 so that base 22 can be disassembled for storage and transportation. Extending from each joint 52, in this embodiment, is a pontoon 26 further described in FIG. 3.

It is desired in a preferred embodiment to connect portions of base 22 together by elastic cord 54 (sometimes referred to as “shock cord”) indicated by the hidden lines. Elastic cord 54 maintains rails 46, 48 and 50, and pontoons 26 in a formed base while in use and allows for disassembly and of base 22 when not in use. It is desired that cord 54 be disposed within the rails and pontoon sections. Cord 54 may be connected within elements 46, 48, 50 and 52 in many manners well known in the art. The significant feature of cord 54 is that it maintains frame 22 in compression when formed for use yet allow elements 46, 48, 50 and 52 to be disassembled when not being utilized as shown in FIG. 2a and 5. Further compressive forces may be applied to maintain base 22 members in connection utilizing retaining band(s) 56.

In one embodiment, sail assembly 24 is connected to base 22 in two positions to adjustably facilitate the maneuverability of WPU 12 of the present invention. Mast 30 is preferably frictionally fitted into a sliding mast connector 58. Mast connector 58 is moveably disposed on bow rail 50 providing positioning of the tack end of sail assembly 24. Mast connector 58 may be secured in a selected position along the bow rail by a locking mechanism 31 formed in a number of ways such as guy lines, clamps, bolts, set screws or the like. As shown locking mechanism 31 is a set screw. Another locking means 31 may be utilized to maintain mast 30 in mast connector 58.

To further maintain and maneuver WPU 12, sail assembly 24 is positioned by connecting fastening mechanism 36 to a position along a sail attitude chain 60. Fastening mechanism 36 may be any device or material such as but not limited to a hook, swivel or cord connectable to attitude chain 60. Fastening mechanism 36 extends from the clew end 76 (FIG. 6) of sail assembly 24. By positioning the tack end of sail assembly 24 in conjunction with positioning the clew end of sail assembly 24, WPU 12 can travel close reaches, beam reaches, broad reaches and runs unlike prior art fishing devices.

Different embodiments of sail attitude chains 60 are shown in FIG. 2. Sail attitude chains 60 may be constructed of numerous materials including a chain having loops, rope, or cloth strips having holes or grommets. Chains 60 are shown running along side rails 46a and 46b. In an alternative embodiment it may be desired to utilize a sail attitude chain 60a extending between rails 46a and 46b providing additional available positions for sail assembly 24. Sail attitude chain 60a may be movably connected by loops or elastic bands between rails 46a and 46b allowing chain 60a to be positioned along the length of rails 46. Sail alignment chains 60 and 60a may be utilized singularly or in combination.

A tacking chain 62 may be provided to achieve additional maneuverability and control over WPU 12. As with sail attitude chain 60, tacking chain may be constructed of numerous types of material. In one embodiment, tacking chain 62 is disposed between rails 46 proximate bow rail 50. Tacking chain 62 may be connected between rails 46 in many different fashions well known in the art. One method of connecting tacking chain 62 is to utilize elastic cord to additionally facilitate the compression connection of rails 46 with bow rail 50. Tacking chain 60 provides a plurality of locations to attach line 18. By selecting the position of sail assembly 24 utilizing mast connector 58 and fastener 36 with attitude chain 60 in conjunction with the attachment of line 18 to tacking chain 62, fisherman 16 has greater control over WPU 12 than is achievable with prior art fishing devices. This range of positioning of sail assembly 24 and utilization of tacking chain 62 facilitates a greater range of angular maneuverability of WPU 12 relative to the prevailing wind direction.

FIG. 2a is a top view of another embodiment of the base 22 of the present invention. Base 22 is shown as constructed for use. Side rails 46a, b are connected to bow rail 50 and stern rail 48 via connectors 52. In this embodiment connectors 52 include T-joints and L-connectors. Extending from each from the bow are side rail extensions 46c. Extensions 46c may be either singularly or in combination connected to connectors 52 by friction fitting, removable locking mechanisms, or adhesive. Pontoons 26, shown by hatched lines are connected removably or by adhesive to extensions 46c and to sections of side rails 46a, b proximate stern rail 48.

Mast connector 58 is moveably disposed to bow rail 50. Bow rail 50 as shown is positioned and secured by a locking mechanism 31. Rudder connector 68 is moveably connected to stern rail 48 and secured in position by a locking mechanism 31.

Base 22 is maintained in a compressed connection by elastic cord 54. In this embodiment base 22 is secured by a single elastic cord 54. Cord 54 is disposed through the interior of base 22 members and secured at it's beginning and ending at 54a, b. Cord 54 maybe secured in numerous ways including, but not limited to knots passing through slots in portions of base 22, connecting to and or passing around rods positioned in base members 22. In effect, elastic cord 54 interconnects base members 22 so as to maintain various members in compressive connection when formed as base 22. Cord 54 allows for substantially all of base members 22 to be disconnected for storage and/or transportation while maintaining the members together and oriented for ease of construction into base 22.

FIG. 3 is a perspective view of pontoon 26 in isolation. As illustrated in FIGS. 1 and 2, pontoons 26 are positioned rail extensions 46c (FIG. 5) removably connected to connectors 52.

In a preferred embodiment pontoons 26 are constructed of ETHAFOAM™ as described above. Pontoons 26 may be formed of other material that is buoyant and desirably weather resistant. In a preferred embodiment, pontoon 26 has an outwardly tapered bow section 64. Tapered bow section 64 desirably extends outwardly from base 22 and rails 46 (FIG. 2) to aid WPU 24 in traveling through the water. Additionally, pontoons 26 have a V-type hull configuration 66 to increase control of WPU 12 and reduce friction as pontoons 26 move through water 14.

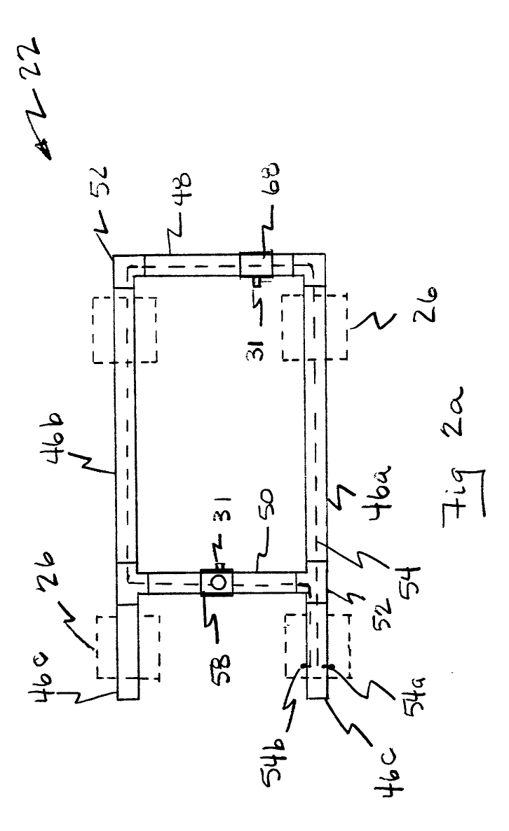

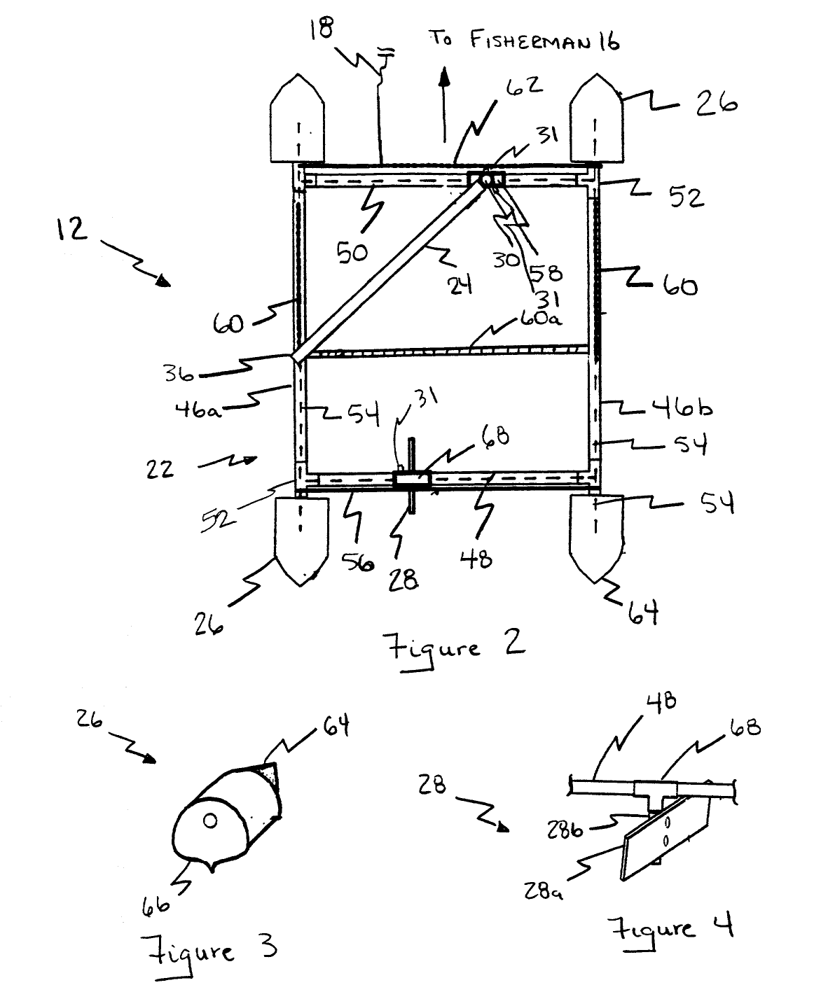

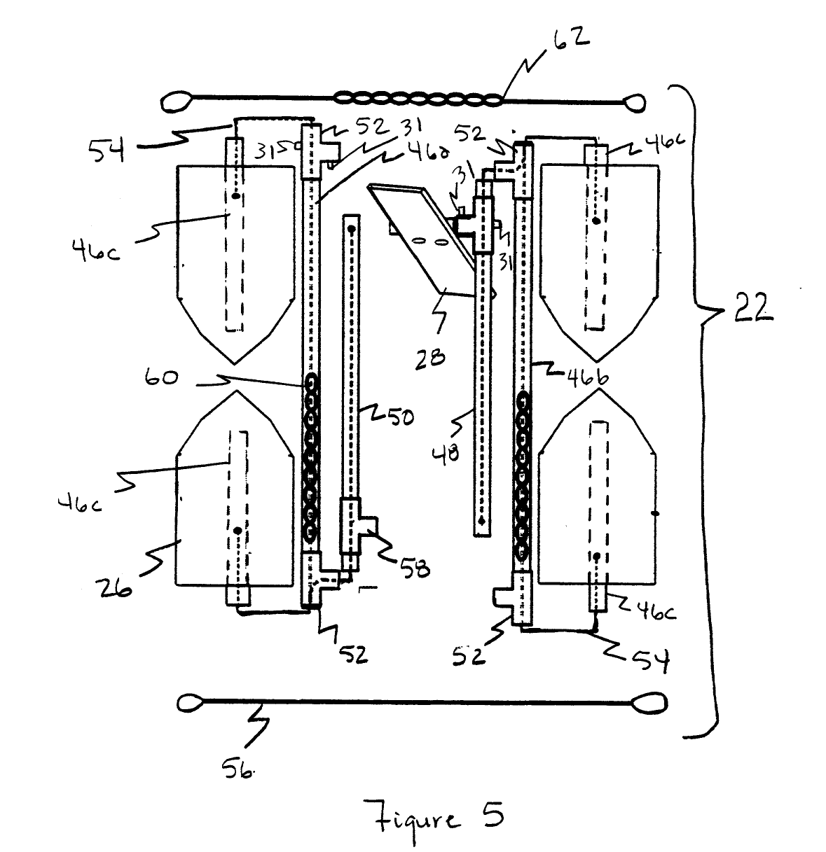

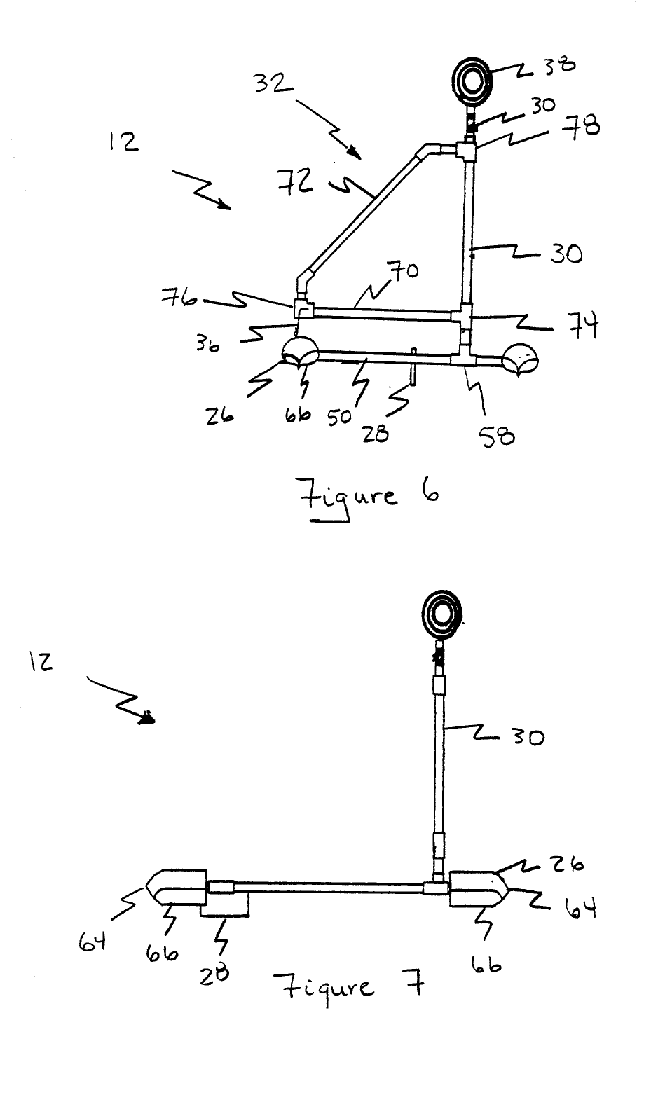

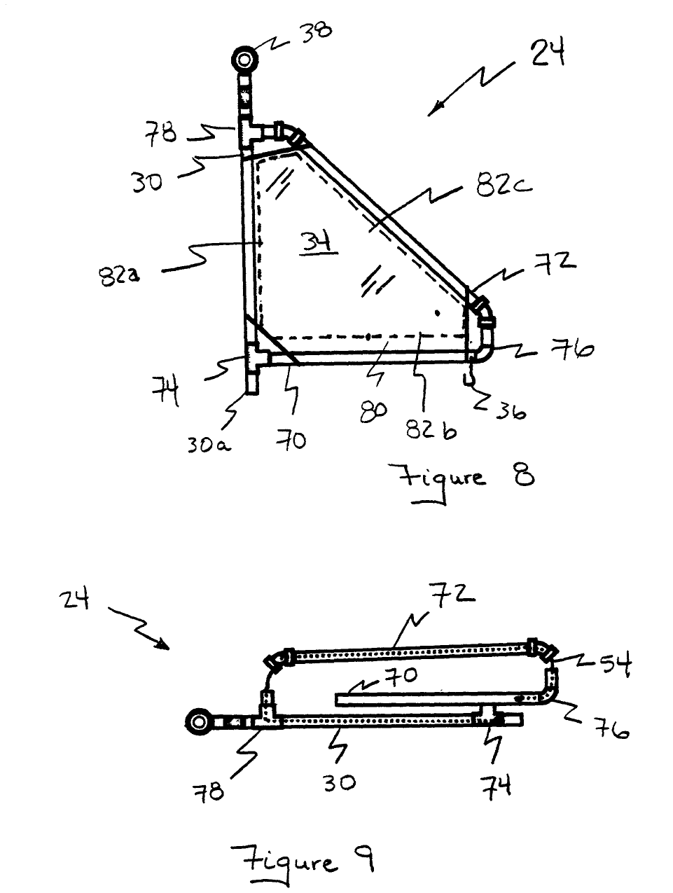

FIG. 4 is a perspective view of the rudder assembly 28 of FIGS. 1 and 2 in isolation. Rudder assembly 28 is an additional feature for control of WPU 12 described with reference to FIGS. 1 and 2.

Rudder assembly 28 includes a rudder 28a connected to a rudder shaft 28b. Rudder shaft 28b is connected to a rudder connector 68. Rudder shaft 28b may be fixedly connected to rudder connector 68 or rotatably connected. Rudder connector 68 is movably disposed on stern rail 48 permitting positioning of rudder assembly 28 in relation to sail assembly 24. Rudder connector 68 may be maintained in a set position by means of many known fastening mechanisms.

FIG. 5 is an exploded view of an embodiment of base 22 disassembled for storage and/or transport. Base 22 is disassembled into two separate sections, each section interconnected by an elastic cord 54. For brevity the breakdown of only one section will be described. Elastic cord 54 is disposed within bow rail 50 though connector 52, side rail 46a, and side rail extensions 46c holding pontoons 26. Cord 54 may be connected within these members in many known ways. The members interconnected by each elastic cord 54 are pulled from their corresponding connector 52 by stretching cord 54. In this manner base 22 is disassembled to a size suitable for storage and transport while at the same time maintaining the various members together for quick reassembly.

As shown in FIG. 5 tacking chain 62 and retaining band 56 are disconnected from base 22. It may not be desired to disconnect chain 62 and band 56 but utilize them for connecting the two halves of base 22 for compact storage.

FIG. 6 is a front view of WPU 12 of the present invention. As shown mast 30 is removably connected to sliding mast connector 58 to bow rail 50.

One embodiment of sail assembly 24 includes a batten frame 32 including a portion of mast 30 forming a luff side, a foot member 70 and a leech member 72. Mast 30 has a tack connector 74 located proximate sliding mast connector 58. Foot member 70 is frictionally connectable within tack connector 74. A clew connector 76 is connected to the opposite end of foot member 70. Leech member 72 is removably connected to clew connector 76 and extends to and is connectable with head connector 78. In this manner a three-sided batten frame 32 is formed. FIG. 6 is a demonstration of only one possible batten frame 32. Another example, not shown, would include foot member 70 and a mast 30 and include a batten extending diagonally between mast 30 and foot member 70 and connectable to sail 34.

FIG. 7 is a side view of WPU 12. FIG. 7 further illustrates the shape of pontoons 26 having bow end 64 and hull section 66.

FIG. 8 is a side view of sail assembly 24 in isolation. Sail 34 includes sleeves 80 formed to dispose a portion of mast 30, foot member 70 and leech member 72 therein. It may be desired to utilize other attaching means to maintain sail 34 in position. Once sail assembly 24 is assembled mast end 30a may be disposed within mast connector 58 (FIGS. 2, 5, 6 and 7).

FIG. 9 is an exploded view of sail assembly 24 disassembled and in isolation. Leech member 72 is disconnected from clew connector 76 and head connector 78. Foot member 70 is disconnected from tack connector 74 and clew member 76. Members 30, 70 and 72 are maintained in relative connection to one another by elastic cord 54. As with base 22 (FIGS. 2 and 5) elastic cord 54 is connected within the relative members to maintain them in frictional connection when assembled as sail assembly 24 for use and to maintain the elements together when sail assembly 24 is disassembled for storage and/or transport.

A method of use of fishing apparatus 10 is now described with reference to FIGS. 1 through 9. First, apparatus 10 is removed from packaging or a traveling pack.

Base 22 is assembled by connecting side rail extensions 46c connected to pontoons 26 to side rails 46a and 46b via joints 52. Attachment cord 54 maintains pontoons 26 and extensions 46c in frictional and compression connection with connectors 52. One or more of extensions 46c may be connected to a connector 52 by adhesive. Stern rail 48 and bow rail 50 are connected to their respective connector 52 as urged by elastic cord 54. The two corresponding sides 46a, b are then interconnected by connecting stern rail 48 and bow rail 50 to a connector 52 of the opposite side of base 22. Tacking chain 62 is then connected between side rails 46. Sail attitude chains 60 are connected along side rails 46. If attitude chains are not connected along side rails 46 a sail attitude chain 60a may be connected between rails 46a and 46b.

Sail assembly 24 is assembled by running mast 30, leech member 72 and foot member 70 into sleeve 80 of sail 34. Leg member 70 may then be frictionally connected between tack connector 74 and clew connector 76. Leech member 72 may be connected between clew connector 76 and head connector 78. Once formed, sail assembly 24 includes a substantially rigid sail 34 having a luff side 82a, a foot side 82b and a leech side 82c. Sail member 24 is then connected to bow rail 50 via mast connector 58. Mast connector 58 and mast 30 and mast connector 58 and bow rail 50 may be individually secured by locking mechanisms 31.

Fisherman 16 having a rod and reel or other similar device prepares a line 18 for fishing. Included on line 18 is a leader section 20 having at least one hook drop 42 extending therefrom. Hook drop(s) 42 may be rigged with lures or hooks for bait fishing. A combination of hook drops 42 may be used in combination. A plurality of floats 44 may be connected to line 18. An end of line 18 is connected to WPU 12. Desirably line 18 is connected to tacking chain 62 to aid in guiding WPU 12 across water 14.

Wind direction in relation to fisherman 16 and the desired fishing location is determined and sail assembly 24 is adjusted to extend WPU 12 and hook drops 42 through a desired fishing area. Direction and maneuverability of WPU 12 are set by moving sliding mast connector 58 along bow rail 50 and positioning of clew fastening mechanism 36 to sail attitude chain 60. Positioning rudder 28 further aids maneuvering of WPU 12 and preventing rotation of WPU 12 in beam winds. Additionally, the positioning of the connection of line 18 to tacking chain 62 allows for additional control of movement of WPU 12.

Once WPU 12 is assembled and connected to line 18 it is placed in water 14. Fishing apparatus 10 of the present invention does not require that the wind be coming from the direction of fisherman 16 to utilize the present device. The ability to position the tack end of sail 34 and the clew end of sail 34 greatly increases the maneuverability of WPU 12 in varying wind conditions. The combination of positioning the tack and clew end of sail 34, positioning rudder 28 and connecting line 18 to tacking chain 62 affords great control over and maneuverability of WPU 12. Further, pontoons 26 and rudder 28 keep WPU 12 on course and alleviate spinning of WPU 12.

By releasing line 18 WPU 12 moves away from fisherman 16 in a selected direction. By selectively placing and releasing tension on line 18 fisherman 16 can maneuver WPU 12 along a fishing path. Fishing apparatus 10 of the present invention enables a fisherman 16 to maneuver WPU 12 running with the wind, in a close reach, beam reach and broad reach in addition to retrieving WPU 12 directly into the wind.

From the foregoing description of the invention, including the drawings, it should be apparent that a method and apparatus for fishing has been disclosed. Although a specific embodiment is shown herein, this has been done solely for the purposes of disclosing the invention in its various aspects, and is not intended to be limiting with the scope of the invention as defined in the claims. It is contemplated that various substitutions, alterations, and or modifications, including but not limited to various design alternatives which may be specifically discussed herein, may be made to the disclosed embodiment without departing from the spirit and scope of the invention. For example, the specific types of material utilized may vary and connections may be threaded entirely or in part to facilitate removable connections.

What is claimed is:

1. A fishing apparatus operationally connected to a fisherman, said fishing apparatus comprising:
a base maneuverable across the surface of a body of water, said base including a bow rail, a stern rail and a pair of side rails interconnected to form a substantially rectangular base;
at least two buoyant pontoons connected to said base;
a sail attitude chain connected along a portion of said base;
a sail assembly having a mast and a batten frame carrying a sail, said mast being rotatably connected to said bow rail;
a fastening mechanism extending from a clew portion of said sail assembly connectable to said sail attitude chain; and
a line having at least one hook drop extending therefrom connected to said base.

2. The fishing apparatus of claim 1 wherein said sail mast is positionally connected to said bow rail.

3. The fishing apparatus of claim 1 further including a rudder connected to said stern rail.

4. The fishing apparatus of claim 3 wherein said rudder is positionally connected to said stern rail.

5. The fishing apparatus of claim 1 further including a tacking chain connected between a portion of said side rails for connecting said line thereto.

6. The fishing apparatus of claim 2 further including a tacking chain connected between a portion of said side rails for connecting said line thereto.

7. The fishing apparatus of claim 1 wherein at least a portion of said pontoons have a tapered bow section.

8. The fishing apparatus of claim 1 wherein at least a portion of said pontoons have a V-shaped hull section.

9. The fishing apparatus of claim 1 wherein at least a portion of said pontoons have a tapered bow section and a portion having a V-shaped hull section.

10. The fishing apparatus of claim 2 wherein at least a portion of said pontoons have a tapered bow section.

11. The fishing apparatus of claim 2 wherein at least a portion of said pontoons have a V-shaped hull section.

12. The fishing apparatus of claim 2 wherein at least a portion of said pontoons have a tapered bow section and a portion having a V-shaped hull section.

13. The fishing apparatus of claim 3 wherein at least a portion of said pontoons have a tapered bow section.

14. The fishing apparatus of claim 3 wherein at least a portion of said pontoons have a V-shaped hull section.

15. The fishing apparatus of claim 3 wherein at least a portion of said pontoons have a tapered bow section and a portion having a V-shaped hull section.

16. The fishing apparatus of claim 5 wherein at least a portion of said pontoons have a tapered bow section.

17. The fishing apparatus of claim 5 wherein at least a portion of said pontoons have a V-shaped hull section.

18. The fishing apparatus of claim 5 wherein at least a portion of said pontoons have a tapered bow section and a portion having a V-shaped hull section.

19. The fishing apparatus of claim 7 further including a tacking chain connected between a portion of said side rails for connecting said line thereto.

20. The fishing apparatus of claim 8 further including a tacking chain connected between a portion of said side rails for connecting said line thereto.

21. The fishing apparatus of claim 9 further including a tacking chain connected between a portion of said side rails for connecting said line thereto.

22. The fishing apparatus of claim 10 further including a tacking chain connected between a portion of said side rails for connecting said line thereto.

23. The fishing apparatus of claim 11 further including a tacking chain connected between a portion of said side rails for connecting said line thereto.

24. The fishing apparatus of claim 12 further including a tacking chain connected between a portion of said side rails for connecting said line thereto.

25. The fishing apparatus of claim 13 further including a tacking chain connected between a portion of said side rails for connecting said line thereto.

26. The fishing apparatus of claim 14 further including a tacking chain connected between a portion of said side rails for connecting said line thereto.

27. The fishing apparatus of claim 15 further including a tacking chain connected between a portion of said side rails for connecting said line thereto.

28. The fishing apparatus of claim 1 further including:
an elastic member interconnecting at least a portion of said base; and
an elastic member interconnected between said mast and said batten frame.

29. The fishing apparatus of claim 2 further including:
an elastic member interconnecting at least a portion of said base; and
an elastic member interconnected between said mast and said batten frame.

30. The fishing apparatus of claim 3 further including:
an elastic member interconnecting at least a portion of said base; and
an elastic member interconnected between said mast and said batten frame.

31. The fishing apparatus of claim 5 further including:
an elastic member interconnecting at least a portion of said base; and
an elastic member interconnected between said mast and said batten frame.

32. The fishing apparatus of claim 6 further including:
an elastic member interconnecting at least a portion of said base; and
an elastic member interconnected between said mast and said batten frame.

33. The fishing apparatus of claim 7 further including:
an elastic member interconnecting at least a portion of said base; and
an elastic member interconnected between said mast and said batten frame.

34. The fishing apparatus of claim 8 further including:
an elastic member interconnecting at least a portion of said base; and
an elastic member interconnected between said mast and said batten frame.

35. A fishing apparatus operationally connected to a fisherman, said fishing apparatus comprising:
a base maneuverable across the surface of a body of water, said base including a bow rail, a stern rail and a pair of side rails interconnected to form a substantially rectangular base;
at least two buoyant pontoons connected to said base;
a sail attitude chain connected along a portion of said base;
a rudder connected to said stern rail;
a sail assembly having a mast and a batten frame carrying a sail, said mast being rotatably and positionally connectable to said bow rail;
a fastening mechanism extending from a clew portion of said sail assembly connectable to said sail attitude chain; and
a line having at least one hook drop extending therefrom connected to said base.

36. The fishing apparatus of claim 35 wherein said rudder is positionally connected to said stern rail.

37. The fishing apparatus of claim 35 further including:
an elastic member interconnecting at least a portion of said base; and
an elastic member interconnected between said mast and said batten frame.

38. The fishing apparatus of claim 36 further including:
an elastic member interconnecting at least a portion of said base; and
an elastic member interconnected between said mast and said batten frame.

39. The fishing apparatus of claim 35 further including a tacking chain connected between a portion of said side rails for connecting said line thereto.

40. The fishing apparatus of claim 36 further including a tacking chain connected between a portion of said side rails for connecting said line thereto.

41. The fishing apparatus of claim 37 further including a tacking chain connected between a portion of said side rails for connecting said line thereto.

42. The fishing apparatus of claim 35 wherein at least a portion of said pontoons have a tapered bow section.

43. The fishing apparatus of claim 35 wherein at least a portion of said pontoons have a V-shaped hull section.

44. The fishing apparatus of claim 35 wherein at least a portion of said pontoons have a tapered bow section and a portion having a V-shaped hull section.

45. The fishing apparatus of claim 36 wherein at least a portion of said pontoons have a tapered bow section.

46. The fishing apparatus of claim 36 wherein at least a portion of said pontoons have a V-shaped hull section.

47. The fishing apparatus of claim 36 wherein at least a portion of said pontoons have a tapered bow section and a portion having a V-shaped hull section.

48. The fishing apparatus of claim 37 wherein at least a portion of said pontoons have a tapered bow section.

49. The fishing apparatus of claim 37 wherein at least a portion of said pontoons have a V-shaped hull section.

50. The fishing apparatus of claim 37 wherein at least a portion of said pontoons have a tapered bow section and a portion having a V-shaped hull section.

51. A fishing apparatus operationally connected to a fisherman, said fishing apparatus comprising:
a base maneuverable across the surface of a body of water, said base including a bow rail, a stern rail and a pair of side rails interconnected to form a substantially rectangular base;
at least two buoyant pontoons connected to said base;
a sail attitude chain connected along a portion of said base;
a tacking chain connected between a portion of said side rails;
a rudder positionally connected to said stern rail;
a sail assembly having a mast and a batten frame carrying a sail, said mast being rotatably and positionally connectable to said bow rail;
a fastening mechanism extending from a clew portion of said sail assembly connectable to said sail attitude chain;
an elastic member interconnecting at least a portion of said base;
an elastic member interconnected between said mast and said batten frame; and
a line having at least one hook drop extending therefrom connected to said tacking chain.

52. The fishing apparatus of claim 51 wherein at least a portion of said pontoons have a tapered bow section.

53. The fishing apparatus of claim 51 wherein at least a portion of said pontoons have a V-shaped hull section.

54. The fishing apparatus of claim 51 wherein at least a portion of said pontoons have a tapered bow section and a portion having a V-shaped hull section.

55. A method of fishing comprising the steps of:
assembling a base having a bow rail, a stern rail and a pair of side rails;
connecting a plurality of pontoons to said base;
attaching a sail attitude chain along a portion of said base;
assembling a sail assembly having a mast and a batten frame carrying a sail;
rotatably connecting said mast to said bow rail;
connecting a clew end of said sail assembly to said sail attitude chain;
connecting a line having at least one hook drop to said base; and
maneuvering said body and said sail assembly on a body of water utilizing the prevailing winds in a manner such that said hook drop is moved through said water.

56. The method of claim 55 further including a rudder connected to said stern rail.

57. The method of claim 56 wherein said rudder is positionally connected to said stern rail.

58. The method of claim 55 further including a tacking chain connected between said side rails for connecting said line.

59. The method of claim 56 further including a rudder connected to said stern rail.

60. The method of claim 55 further including:
an elastic member interconnecting at least a portion of said base; and
an elastic member interconnected between said mast and said batten frame.

61. The method of claim 56, further including:
an elastic member interconnecting at least a portion of said base; and
an elastic member interconnected between said mast and said batten frame.

62. A method of fishing comprising the steps of:
assembling a base having a bow rail, a stern rail and a pair of side rails;
connecting a plurality of pontoons to said base;
attaching a sail attitude chain along a portion of said base;
assembling a sail assembly having a mast and a batten frame carrying a sail;
rotatably connecting said mast to said bow rail;
positioning said mast along the length of said bow rail;
connecting a clew end of said sail assembly to said sail attitude chain;
positioning a rudder to said stern rail;
connecting a line having at least one hook drop to said base; and
maneuvering said body and said sail assembly on a body of water utilizing the prevailing winds in a manner such that said hook drop moves through said water.

63. The method of claim 62 wherein at least a portion of said pontoons have a tapered bow section.

64. The method of claim 62 wherein at least a portion of said pontoons have a V-shaped hull section.

65. The method of claim 62 wherein at least a portion of said pontoons have a tapered bow section and a portion having a V-shaped hull section.

66. The method of claim 62, further including:
an elastic member interconnecting at least a portion of said base; and
an elastic member interconnected between said mast and said batten frame.

67. The method of claim 66 wherein at least a portion of said pontoons have a tapered bow section.

68. The method of claim 67 wherein at least a portion of said pontoons have a V-shaped hull section.

69. The method of claim 68 wherein at least a portion of said pontoons have a tapered bow section and a portion having a V-shaped hull section.
